(19) United States
(12) Patent Application Publication
(10) Pub. No.: US 2013/0225748 A1
(43) Pub. Date: Aug. 29, 2013

(54) WHITE INK COMPOSITIONS

(71) Applicants: Vladimir Jakubek, Corvallis, OR (US); Cory J. Ruud, Corvallis, OR (US)

(72) Inventors: Vladimir Jakubek, Corvallis, OR (US); Cory J. Ruud, Corvallis, OR (US)

(21) Appl. No.: 13/409,074

(22) Filed: Feb. 29, 2012

(51) Int. Cl. C09D 11/10

(52) U.S. Cl. 524/497; 524/560; 524/556; 524/558; 524/577; 524/566; 524/507

(57) ABSTRACT

White ink compositions include an aqueous ink vehicle, white pigment particles, and hollow polymer particles comprising a cross-linked polymer shell. An amount of hollow particles in the white ink composition is less than 5% by weight. The white ink compositions have a viscosity of 50 centipoise or less.

### CROSS-REFERENCE TO RELATED APPLICATIONS

N/A

### STATEMENT REGARDING FEDERALLY SPONSORED RESEARCH OR DEVELOPMENT

N/A

### BACKGROUND

One of the colors used in printing with ink is white, which is obtained using a white ink. In order for a white ink to be efficient, it must hide the color of the underlying surface of a print medium. That is, for example, a printed white feature must have acceptable opacity or sufficient ability to block transmission of light to the print medium underlying the printed white feature.

### BRIEF DESCRIPTION OF THE DRAWINGS

The drawings provided herein are not to scale and are provided for the purpose of facilitating the understanding of certain examples in accordance with the principles described herein and are provided by way of illustration and not limitation on the scope of the appended claims.

FIG. 1 illustrates in macroscale a schematic of a print medium according to an example in accordance with the principles described herein.

FIG. 2 is schematic of the formation of the print medium of FIG. 1 according to an example in accordance with the principles described herein.

### DETAILED DESCRIPTION

Examples in accordance with the principles described herein provide white ink compositions that comprise an aqueous ink vehicle, white pigment particles, and hollow polymer particles comprising a hollow interior and a shell formed of a cross-linked polymer wherein an amount of the hollow polymer particles in the ink composition is less than 5% by weight. The white ink compositions have a viscosity of 50 centipoise or less. Features printed with examples of the white ink compositions exhibit enhanced opacity or light scattering efficiency.

The phrase “opacity” refers to an ability of a printed feature to scatter light. The greater the amount of light that is scattered by the printed feature, the greater is the opacity of the printed feature. Opacity may be referred to in a quantitative sense as L*(lightness), which is a part of L*, a*and b* coordinates as defined in CIELAB®. CIELAB® is color space specified by the International Commission on Illumination. In CIELAB definition, lightness of L*=100 yields white and lightness of L*=0 yields black. With respect to white inks, the greater the opacity of a feature printed using such white inks, the whiter is the appearance of the printed feature to the naked eye of the observer. A targeted level of opacity for the white ink compositions in accordance with the principles described herein is at least about 70, for example.

In some examples, the opacity (L*) of white ink compositions in accordance with the principles described herein is at least about 75, or at least about 80, or at least about 85, or at least about 90, or at least about 95, or at least about 96, or at least about 97, or at least about 98, or at least about 99. The opacity (L*) of examples of white ink compositions in accordance with the principles described herein is in the range of about 70 to about 100, or about 80 to about 99, or about 80 to about 95, or about 85 to about 95, or about 90 to about 95, for example. In some applications it is merely necessary to provide contrast with a background medium where a change of L* is at least about 25, or at least about 40, or at least about 60, or at least about 80, for example.

The phrase “white pigment particles” refers to particles of substances that, when incorporated into an ink, impart a white color to a feature printed using the white ink containing the white pigment particles. The term excludes the presence of any colored pigment including colored pigment particles. Examples, by way of illustration and not limitation, of white pigment particles include titanium dioxide, zinc oxide, barium carbonate, silicon dioxide, zinc sulfide, barium sulfate, magnesium carbonate, lead carbonate, calcium sulfate, calcium carbonate, antimony oxide, aluminum hydroxide, kaolin, and mixtures of two or more of the above.

The amount of white pigment particles in the white ink compositions in accordance with the principles described herein is that which is sufficient to impart a white color to a printed feature, which has the level of opacity as discussed above. The amount of the white pigment particles in the white ink composition depends on one or more of a number of factors such as the nature of the white pigment, the nature of a print medium, and the amount of ink printed, for example. In some examples, the white pigment particles have an average diameter of about 100 nm to about 500 nm, or about 100 nm to about 400 nm, or about 100 nm to about 300 nm, or about 100 nm to about 200 nm, or about 150 nm to about 500 nm, or about 150 nm to about 400 nm, or about 150 nm to about 300 nm, or about 150 nm to about 200 nm, or about 150 nm to about 350 nm, for example.

In some examples, the amount (by weight) of white pigment particles in a white ink composition in accordance with the principles described herein is less than about 25%, or less than about 20%, or less than about 15%, or less than about 10%, or less than about 9%, or less than about 8%, or less than about 7%, or less than about 6%, or less than about 5%, or less than about 4%, or less than about 3%, or less than about 2%, for example. In some examples, the amount (by weight) of white pigment particles in the white ink composition is about 1% to about 25%, or about 1% to about 20%, or about 1% to about 15%, or about 1% to about 10%, or about 1% to about 5%, or about 2% to about 20%, or about 2% to about 15%, or about 2% to about 10%, or about 2% to about 5%, for example.

In some examples the white pigment particles are in the form of a dispersion in an aqueous medium, which is added to an ink vehicle in an amount such that the final concentration of the white pigment particles in the ink composition is as set forth above. The amount (by weight) of white pigment particles in the dispersion is about 3% to about 80%, or about 10% to about 70%, or about 20% to about 80%, or about 30% to about 60%, for example. In some examples the white pigment particles comprise a coupling agent (or dispersing agent) as discussed more fully herein below.

White ink compositions in accordance with the principles described herein may be formulated with less total solids content than compositions formulated without hollow polymer particles. In some examples, the amount by weight of total solids in white ink compositions of the present disclosure is less than about 30%, or less than about 25%, or less than about 24%, or less than about 21%, or less than about 20%, or less than about 15%, or less than about 10%, or less than about 9%, or less than about 8%, or less than about 6.5%, or less than about 5%, or less than about 4.5%, or less than about 3%, for example, depending on the amount by weight of the white pigment particles in the white ink composition in accordance with the principles described herein. In some examples, the amount (by weight) of total solids in the white ink composition is about 1% to about 30%, or about 1% to about 25%, or about 1% to about 20%, or about 1% to about 15%, or about 1% to about 10%, or about 1% to about 5%, or about 2% to about 25%, or about 2% to about 20%, or about 2% to about 15%, or about 2% to about 10%, or about 3% to about 24%, or about 4% to about 21%, or about 4% to about 15%, or about 4% to about 10%, or about 5% to about 30%, or about 5% to about 25%, or about 5% to about 20%, or about 5% to about 15%, or about 6% to about 24%, or about 6% to about 10%, for example.

The phrase “ink vehicle” refers to any aqueous liquid that is used to carry examples of the white ink compositions in accordance with the principles described herein to a printing medium. A wide variety of liquid vehicle components may be used. In some examples, by way of illustration and not limitation, the ink vehicle comprises water and may comprise one or more other liquid vehicle components. In some examples, the ink vehicle may include a polar organic solvent and one or more of a variety of different agents for affecting various properties of the ink composition. The amount of water in the white ink composition is dependent, for example, on the amount of other components of the white ink composition. In some examples, the amount of water in the white ink composition by weight is in the range of about 40% to about 90%, or about 50% to about 90%, or about 60% to about 90%, or about 60% to about 80%, or about 60% to about 70%, or about 65% to about 85%, or about 65% to about 75%, or about 65% to about 70%, for example, with the remaining percentage being the other components of the ink composition.

Examples of water-soluble polar organic solvents that may be included in the ink vehicle are, but are not limited to, alcohols, polyhydric alcohols, ketones, keto-alcohols, ethers, esters, glycols, amines, lactams, ureas, amides, sulfoxides, sulfolanes, nitriles, and pyrrolidones, for example, and combinations of two or more of the above. An amount of the organic solvent in the ink vehicle is dependent one or more of the nature of the white pigment particle, the nature of the intended print medium, the control of penetration rates, and the solubility of ink components, for example. In some examples the amount of organic solvent in the ink vehicle of the white ink composition is about 1% to about 30%, or about 1% to about 20%, or about 1% to about 10%, or about 1% to about 5%, or about 5% to about 30%, or about 5% to about 20%, or about 5% to about 10%, or about 10% to about 30%, or about 10% to about 20%, by weight of the white ink composition, for example.

As mentioned above, examples of white ink compositions in accordance with the principles described herein comprise hollow polymer particles (also referred to as ‘hollow particles’ or ‘hollow spheres’ herein) comprising a cross-linked polymer shell and a hollow interior. The hollow interior comprises a fluid of its ambient environment. Cross-linked polymers are polymers in which the long chains of polymers are linked together increasing the molecular mass of the polymer as a result. The cross-linked polymer may comprise a single monomer unit or two or more different monomer units. Cross-linking may be accomplished by chemical means, thermal means or radiation means. Chemical cross-linking involves the use of one or more cross-linking agents to cross-link the monomers of the cross-linked polymer. Radiation cross-linking involves the use of radiation in the cross-linking process. In some examples the density of the cross-linking in the polymer shell is about 1.0 to about 1.4 g/cm³, or about 1.0 to about 1.3 g/cm³, or about 1.0 to about 1.2 g/cm³, or about 1.0 to about 1.1 g/cm³, or about 1.1 to about 1.4 g/cm³, or about 1.2 to about 1.4 g/cm³, for example.

The cross-linked polymer may be a latex polymer. In some examples, the cross-linked polymer is an acrylic latex polymer, which may be formed from one or more acrylic monomers, and thus, may be said to comprise acrylic monomer residues or methacrylic monomer residues. Examples of monomers of an acrylic latex polymer include, by way of illustration and not limitation, acrylic monomers, such as, for example, acrylate esters, acrylamides, and acrylic acids, and methacrylic monomers, such as, for example, methacrylate esters, methacrylamides, and methacrylic acids. The cross-linked polymer may be a vinyl aromatic polymer, which may be formed from one or more vinyl aromatic monomers including, but not limited to, styrene, styrene-butadiene, p-chloromethylstyrene, divinyl benzene, vinyl naphthalene and divinyl naphthalene, for example. In some examples, the polymer may be a homopolymer or copolymer of an acrylic monomer and another monomer such as, for example, a vinyl aromatic monomer or an acrylic monomer different from the other acrylic monomer. In some examples in accordance with the principles described herein, the polymers that form the shell of the cross-linked hollow polymer particles for use in the white ink compositions in accordance with the principles described herein include, by way of illustration and not limitation, methyl methacrylate, methacrylic acid, ethylene glycol dimethacrylate, styrene, acrylonitrile, divinyl benzene, and mixtures thereof.

The thickness of the cross-linked polymer shell of the hollow particles is that which is sufficient to maintain the integrity of the hollow interior such that the hollow interior does not collapse or coalesce. The thickness depends in part on one or both of the nature of the polymer and the extent of crosslinking, for example. In some examples, the cross-linked polymer shell of the hollow particles has a thickness of about 15 nanometers (nm) to about 200 nm, or about 15 nm to about 150 nm, or about 15 nm to about 100 nm, or about 15 nm to about 50 nm, or about 25 nm to about 200 nm, or about 25 nm to about 150 nm, or about 25 nm to about 100 nm, or about 25 nm to about 75 nm or about 25 nm to about 50 nm, or about 40 nm to about 60 nm, for example. In some examples, the average diameter of the hollow cross-linked polymer particles is about 100 nm to about 600 nm, or about 115 nm to about 615 nm, or about 200 nm to about 600 nm, or about 200 nm to about 500 nm, or about 250 nm to about 500 nm, or about 250 nm to about 400 nm, or about 250 nm to about 300 nm, or 300 nm to about 500 nm, or about 300 nm to about 400 nm, for example. The cross-linked polymer shell substantially maintains the hollow interior even as dispersed with the white pigment particles in the aqueous ink vehicle.

In some examples, the average diameter of the hollow interior of the hollow cross-linked polymer particles may range from about 100 nm to about 600 nm, or about 100 nm to about 500 nm, or about 100 nm to about 400 nm, or about 150 nm to about 600 nm, or about 150 nm to about 500 nm, or about 150 nm to about 400 nm, or about 200 nm to about 600 nm, or about 200 nm to about 500 nm, or about 200 nm to about 400 nm, for example, depending on the average diameter of the hollow polymer particle and the average thickness of the shell. In the dry state, the hollow interior of the hollow particles may comprise air (e.g., dry state ambient fluid). In the white ink compositions according to the principles herein, the interiors of the hollow particles comprise the aqueous ink vehicle (e.g., wet state ambient fluid). In particular, the aqueous ink vehicle does not collapse the cross-linked polymer shells of the hollow particles in the white ink composition. For a printed feature or image using the white ink compositions according to the principles described herein, the aqueous ink vehicle is evaporated from the hollow interiors of the hollow particles when the printed feature is dried, and the hollow interiors of the dried hollow particles fill with a corresponding dry state ambient fluid (e.g., air). The hollow particles facilitate light scattering in the printed dried feature. In particular, the greater the difference in refractive indices between the cross-linked polymer shell of the hollow particle and the ambient environment (which includes, e.g., air-filled hollow interior of the hollow particle), the greater is the enhancement in light scattering. The light scattering capabilities of the hollow particles facilitate maintaining the targeted opacity levels described above for the white ink compositions according to the principles described herein.

The glass transition temperature of the cross-linked polymer of the hollow particles is about 30° C. to about 120° C., for example. In some examples the glass transition temperature of the cross-linked polymer of the hollow particles may range from about 30° C. to about 100° C., or about 30° C. to about 60° C., or about 50° C. to about 120° C., or about 50° C. to about 110° C., or about 50° C. to about 100° C.

Examples, by way of illustration and not limitation, of hollow cross-linked polymer particles in accordance with the principles described herein include those sold by Rohm and Haas Company (Philadelphia Pa.), now owned by Dow Chemical Company (Midland, Mich.), under the trademark ROPAQUE®, which include, for example, ROPAQUE® ULTRA E hollow polymer particles. Other commercial hollow polymer particles include, but are not limited to, POLYBEAD® Hollow Microspheres sold by Polysciences, Inc. (Warrington, Pa.), SPINDRIFT beads sold by Dulux (Australia), Dow HS 2000NA plastic pigment and Dow 3000NA plastic pigment (carboxylated styrene/acrylate copolymers) sold by Dow Chemical Company, Dow Latex HSB 3042NA (carboxylated styrene/butadiene copolymer) sold by Dow Chemical Company, VONCOAT and GRANDOL (both being acrylic/styrene copolymers) sold by Dainippon Ink and Chemicals, Inc. (Japan), Latex SBL 8801 (polystyrene) by Asahi Kasei Kogyo K. K and HIQUE 2050 sold by Nae Woi Korea (Korea), for example.

The hollow cross-linked polymer particles may also be synthesized by polymerization of selected monomer units. Selected monomer units can include acrylic and methacrylic monomers (methyl methacrylate, t-butylmethacrylate, methyl acrylate, ethyl(meth)acrylate, butyl(meth)acrylate, 2-ethylhexyl(meth)acrylate, benzyl(meth)acrylate, lauryl(meth)acrylate, oleyl(meth)acrylate, palmityl(meth)acrylate, stearyl(meth)acrylate, hydroxyl containing (meth)acrylate (hydroxyethylacrylate, hydroxyethylmethacrylate, hydroxypropylacrylate, hydroxypropylmethacrylate, and 2,3-dihydroxypropyl methacrylate)), styrene monomers (styrene and styrene derivatives (vinyltoluene)), isoprene (latex), acid monomers (acrylic acid, methacrylic acid, and mixtures thereof and acryloxypropionic acid, methacryloxypropionic acid, and acryloxyacetic acid), non-ionic monoethylenically unsaturated monomers (ethylene, vinyl esters (vinyl acetate, vinylformate, vinylacetate, vinylpropionate, vinylbenzoate, vinylpivalate, vinyl methacrylate)), polyethylenically unsaturated monomer (ethylene glycol di(meth)acrylate, allyl(meth)acrylate, 1,3-butane-diol di(meth)acrylate, diethylene glycol di(meth)acrylate, trimethylol propane trimethacrylate, and divinyl benzene), for example, and combinations thereof.

The amount of hollow cross-linked polymer particles in the white ink compositions in accordance with the principles described herein is that which is sufficient to reduce the amount of white pigment particles in the white ink composition to about 1% to about 25% and maintain the targeted opacity levels (L*) described above. In some examples, the amount of white pigment particles in the white ink composition is reduced to about 1% to about 20%, or about 1% to about 15%, or about 1% to about 10%, or about 1% to about 5%, or about 5% to about 25%, or about 5% to about 20%, or about 5% to about 15%, or about 5% to about 10%, or about 2% to about 10%, or about 2% to about 5%, or about 3% to about 8%, or about 3% to about 6%, or about 3% to about 4%, for example, while maintaining the targeted opacity levels (L*). The amount of the hollow cross-linked polymer particles in the white ink composition depends on a number of factors such as, for example, the nature of the white pigment, the nature of a print medium, and the nature of the printing technology, for example.

In some examples, the amount (by weight) of hollow cross-linked polymer particles in the white ink composition is less than 5%, or less than about 4%, or less than about 3%, or less than about 2%, or less than about 1%, or less than about 0.5%, for example. In some examples, the amount (by weight) of hollow cross-linked polymer particles in the white ink composition is about 0.1% to 5%, or about 0.1% to about 4.5%, or about 0.1% to about 4%, or about 0.1% to about 3%, or about 0.1% to about 2%, or about 0.1% to about 1%, or about 0.1% to about 0.5%, or about 0.5% to 5%, or about 0.5% to about 4%, or about 0.5% to about 3%, or about 0.5% to about 2%, or about 0.5% to about 1%, or about 0.5% to about 0.8%, or about 1% to 5%, or about 1% to about 4%, or about 1% to about 3%, or about 1% to about 2%, for example. Since less than 5% by weight of hollow cross-linked polymer particles are present in the white ink compositions in accordance with the principles described herein, reagent costs are reduced, for example. Moreover, total solids content is also reduced, because the white ink compositions in accordance with the principles described herein contain low amounts of white pigment particles and hollow cross-linked polymer particles. The white ink compositions in accordance with the principles described herein may be produced less expensively and have greater jetting reliability than ink compositions of higher solids content.

Examples of white ink compositions in accordance with the principles described herein may further include a soluble polyurethane having a molecular weight of about 500,000 or less, or about 200,000 or less, or about 100,000 or less, or about 60,000 or less, or about 50,000 or less, or about 40,000 or less, or about 30,000 or less. The molecular weight of the soluble polyurethane may be in the range of about 1,000 to about 500,000, or about 5,000 to about 500,000, or about 10,000 to about 500,000, or about 1,000 to about 300,000, or about 1,000 to about 200,000, or about 1,000 to about 100,000, or about 1,000 to about 50,000, or about 5,000 to about 200,000, or about 5,000 to about 100,000, or about 5,000 to about 50,000, for example. The phrase “soluble polyurethane” means that the polyurethane is soluble in an aqueous ink vehicle of the white ink compositions at least in an amount (by weight) of about 5%, or at least about 3%, or at least about 0.5%, for example, at a temperature of about 20° C. to about 50° C.

In some examples in accordance with the principles described herein, the polyurethane may be, but is not limited to, an aliphatic polyurethane, an aromatic polyurethane, an anionic polyurethane, non-ionic polyurethane, aliphatic polyester polyurethane, aliphatic polycarbonate polyurethane, an aliphatic acrylic modified polyurethane, an aromatic polyester polyurethane, an aromatic polycarbonate polyurethane, an aromatic acrylic modified polyurethane, an aromatic polyester polyurethane, an aromatic polycarbonate polyurethane, or an aromatic acrylic modified polyurethane, for example, or a combination of two or more of the above.

In some embodiments, soluble polyurethane polymers useful as an additive can be linear segmented co-polymers joined by urethane links and can be formed using step-growth polymerization, such as, for example, by reacting a monomer containing at least two isocyanate functional groups with another monomer containing at least two alcohol groups in the presence of a catalyst. Such polyurethane additives can be capable of surfactant-like behavior in aqueous solutions. In addition to segments produced by reaction of diols with diisocyanates, polyurethane additives can also have segments based on acid bearing monomers (hydrophilic blocks). These segments enable moderate to good solubility of the additive in water-based formulations. Polyurethane additives can include polyether polyols, aliphatic isocyanates and acid groups, for example. In some examples the polyether polyol can be a difunctional polyether polyol such as polyethylene glycol (PEG), polypropylene glycol (PPG) and polytetramethylene glycol (PTMG). In some examples the aliphatic-isocyanate can be hexamethylene isophorone diisocyanate (IPDI), diisocyanate-1,6 (HDI), 4,4-dicyclohexylmethane-diisocyanate (H12-MDI), cyclohexane diisocyanate (CHDI), tetramethylxylene diisocyanate (TMXDI), and 1,3-bis(isocyanatomethyl)cyclohexane (H6XDI). In some examples, polyurethane additives include polytetramethylene glycol (PTMG) as the polyether polyol, isophorone diisocyanate (IPDI) as aliphatic isocyanate and dimethylolpropionic acid (DMPA) as acid group.

Soluble polyurethane used as an additive herein can have an average molecular weight ranging from about 1,000 to about 500,000 and an acid number in the range from 10 to 150 mg KOH/g polymer. In some other examples, the polyurethane additive has an average molecular weight ranging from about 2,000 to about 200,000 or ranging from about 5,000 to about 100,000, for example. In yet some other examples, the acid number of the polyurethane additive is in the range of from about 20 to about 100, or in the range of from about 30 to about 75, for example. The acid number is expressed in milligrams of KOH required to neutralize one gram of the polymer.

In some examples in accordance with the principles described herein, the white ink composition encompasses polyurethane additives that are soluble amphiphilic polymers having an average molecular weight ranging from about 5,000 to about 100,000 and an acid number in the range of from about 30 to about 75 mg KOH/g polymer.

The amount of soluble polyurethane in the white ink compositions together with the amount of hollow cross-linked polymer particles in accordance with the principles described herein is that which is sufficient to enhance the reduction of the amount of white pigment particles in the white ink composition to about 1% to about 25% and still maintain the targeted opacity levels (L*) described above. The amount of the soluble polyurethane in the white ink composition depends on a number of factors such as, for example, the nature of the soluble polyurethane, the nature of the white pigment, the nature of the hollow cross-linked polymer particles, the nature of a print medium, and the nature of the print technology, for example. In some examples, the amount (by weight) of soluble polyurethane in the white ink composition is about 0.1% to about 5%, or about 0.1% to about 4%, or about 0.1% to about 3%, or about 0.1% to about 2%, or about 0.1% to about 1%, or about 0.5% to about 5%, or about 0.5% to about 4%, or about 0.5% to about 3%, or about 0.5% to about 2%, or about 0.5% to about 1%, or about 1% to about 5%, or about 1% to about 4%, or about 1% to about 3%, or about 1% to about 2%, for example. In some examples the amount (by weight) of soluble polyurethane in the white ink composition is less than about 2%.

The white ink compositions in accordance with the principles described herein are substantially free from emulsion polyurethane resin particles, which means that the white ink compositions (by weight) contain less than about 5% of emulsion polyurethane resin particles. For example, the white ink compositions may contain less than about 4%, or less than about 3%, or less than about 2%, or less than about 1%, or less than about 0.5%, of such emulsion polyurethane resin particles.

As mentioned above, the white pigment particles of the white ink compositions in accordance with the principles described herein may further include a coupling agent, which, as discussed above, is added to the white pigment particle composition that is added to the ink vehicle to form the white ink composition. The coupling agent reacts with the surface of the white pigment particles and becomes covalently bound thereto. Examples of suitable coupling agents include, but are not limited to, water-soluble anionic species of low and high molecular weight such as phosphates and polyphosphates, phosphonates and polyphosphonates, phosphinates and polyphosphinates, carboxylates (for example, citric acid or oleic acid), polycarboxylates (for example, acrylates and methacrylates), silane coupling agents such as, e.g., hydrolysable alkoxysilanes with alkoxy group attached to water-soluble (hydrophilic) moieties such as water-soluble polyether oligomer chains.

Examples of silane coupling agents include, but are not limited to, silane coupling agents containing hydrophilic functional groups, such as amino, diamino, triamino, ureido, poly(ether), vinyl, chloro, epoxy, mercapto, glycidol functional groups and their hydrolysis product. Examples, by way of illustration and not limitation, of silane coupling agents that may be employed in examples of ink compositions in accordance with the principles described herein include (aminoethyl) aminopropyl-triethoxysilane, (aminoethyl) aminopropyl-trimethoxysilane, (aminoethyl) aminopropyl-methyldimethoxysilane, aminopropyl-triethoxysilane, aminopropyl-trimethoxysilane, glycidolpropyl-trimethoxysilane, ureidopropyltrimethoxysilane and polyether-triethoxysilane, polyether-trimethoxysilane hydrolysis product of aminopropyl-trimethoxysilane and hydrolysis product of (aminoethyl) minopropyl-trimethoxysilane, for example. In some examples, the silane coupling agent may be, but is not limited to, a polyether alkoxysilane, which may be commercially available as, for example, SILQUEST®A-1230 manufactured by Momentive Performance Materials (Demopolis, Ala.), and DYNASYLAN® 4144 manufactured by Evonik Degussa Corporation (Mobile Ala.).

The amount of coupling agent added to a white pigment particle dispersion is that which is sufficient to treat the surface of these pigments and make the pigment dispersion well dispersed and stable in the ink vehicle. The amount of the coupling agent added to the white pigment particles depends on a number of factors such as, for example, the nature of the coupling agent, the nature of the white pigment particles, the nature of the hollow cross-linked polymer particles, and the nature of a print medium, for example. In some examples, the amount (by weight) of coupling agent added to the white pigment particle dispersion is about 0.05% to about 25%, or about 0.05% to about 20%, or about 0.05% to about 15%, or about 0.05% to about 10%, or about 0.05% to about 5%, or about 0.05% to about 1%, or about 0.1% to about 25%, or about 0.1% to about 20%, or about 0.1% to about 15%, or about 0.1% to about 10%, or about 0.1% to about 5%, or about 0.5% to about 25%, or about 0.5% to about 20%, or about 0.5% to about 15%, or about 0.5% to about 10%, or about 0.5% to about 5%, or about 0.5% to about 1%, or about 1% to about 25%, or about 1% to about 20%, or about 1% to about 15%, or about 1% to about 10%, or about 1% to about 5%, or about 5% to about 25%, or about 5% to about 20%, or about 5% to about 15%, or about 5% to about 10%, for example.

The viscosity of the white ink compositions in accordance with the principles described herein is less than about 50 centipoise (cps), for example. In some examples, the viscosity of the white ink compositions is less than about 40 cps, or less than about 30 cps, or less than about 20 cps, or less than about 10 cps, or less than about 5 cps, for example. In some examples the viscosity of the white compositions is in the range of about 0.5 to about 50 cps, or about 0.5 to about 40 cps, or about 0.5 to about 30 cps, or about 0.5 to about 20 cps, or about 0.5 to about 10 cps, or about 0.5 to about 5 cps, or about 0.5 to about 1 cps, or about 1 to about 50 cps, or about 1 to about 40 cps, or about 1 to about 30 cps, or about 1 to about 20 cps, or about 1 to about 10 cps, or about 1 to about 5 cps, or about 2 to about 50 cps, or about 2 to about 40 cps, or about 2 to about 30 cps, or about 2 to about 20 cps, or about 2 to about 10 cps, or about 2 to about 5 cps, or about 3 to about 50 cps, or about 3 to about 40 cps, or about 3 to about 30 cps, or about 3 to about 20 cps, or about 3 to about 10 cps, or about 3 to about 5 cps, for example.

The viscosity described above is the viscosity at a particular dispensation temperature (that is, a temperature at which the white ink composition is emitted from an ink dispensing apparatus wherein dispensing may be by jetting, for example) of about 1° C. to about 90° C., for example. In some examples, the dispensation temperature may range from about 5° C. to about 60° C., or about 10° C. to about 60° C., or about 20° C. to about 60° C., or about 5° C. to about 40° C., or about 5° C. to about 30° C., or about 5° C. to about 20° C., or about 10° C. to about 40° C., or about 10° C. to about 30° C., or about 15° C. to about 30° C., or about 25° C. to about 80° C., or about 5° C. to about 15° C., for example. In some examples, white ink compositions in accordance with the principles described herein have a viscosity similar to that of water. In some examples, the white ink compositions have a viscosity within the range of about 1.0 to about 10 cps, or within the range of about of about 1.0 to about 7.0 cps, as measured at 25° C.

It is noted that ink formulations relying solely on titanium dioxide pigment as the white colorant do not achieve acceptable opacity even at relatively high concentrations of titanium dioxide. Furthermore, the higher the concentration of the white pigment, the more difficult it is to achieve acceptable jetting properties for the resulting white ink employed in an inkjet printer. In addition, the cost of the white ink is increased as the concentration of the white pigment is increased. White ink compositions that can yield features having acceptable opacity at lower concentrations of white pigment are targeted according to the principles described herein. In particular, the white ink compositions in accordance with the principles described herein exhibit the targeted opacity levels described above with an amount of white pigment particles that is less than the amount that would be necessary in the absence of the hollow cross-linked polymer particles used in the white ink compositions in accordance with the principles described herein.

Furthermore, the white ink compositions comprising hollow cross-linked polymer particles together with the soluble polyurethane in accordance with the principles described herein contain less total solids than corresponding compositions that do not comprise hollow polymer particles and soluble polyurethane. In some examples, the solids content (by weight) of examples of white ink compositions in accordance with the principles described herein is described above.

In some examples, the ink vehicle of the white ink compositions may include one or more of a variety of different agents or additives for affecting various properties of the ink composition. The additives include, but are not limited to, one or more of surfactants or wetting agents (e.g., surfactants containing silicone compounds or fluorinated compounds), rheology modifiers, buffers, biocides, viscosity modifiers, sequestering agents, slip components, leveling agents, preservatives, anti-molding agents, anti-foaming agents, polymeric binders, and stabilizers such as, e.g., storage stability enhancing agents, for example. The total amount by weight of additives in the white ink compositions is about 0.1% to about 1%, or about 0.1% to about 0.5%, or about 0.1% to about 0.2%, or about 0.2% to about 1%, or about 0.2% to about 0.5%, or about 0.5% to about 1%, for example.

In an example in accordance with the principles described herein, a white ink composition comprises an ink vehicle, 1% to about 20% by weight of titanium dioxide particles, and 0.1% to 5% by weight of hollow particles comprising a cross-linked polymer shell and a hollow interior wherein the white ink composition has a viscosity of 50 centipoise or less. The white ink composition example is compatible with inkjet printing technologies, for example.

Some examples in accordance with the principles described herein are directed to methods of reducing an amount of white pigment particles in a white ink composition. The method comprises incorporating, into an ink vehicle, hollow cross-linked polymer particles in an amount sufficient to reduce the amount of white pigment particles in the ink vehicle of the white ink composition to about 1% to about 25%. In some examples, the amount of hollow particles in the white ink composition will keep one or more of the viscosity at 50 cps or less, the solids content less than 30%, and the opacity L* greater than 70 for the white ink composition made by the method according to the principles described herein. In some examples, the white pigment particles and the amount (by weight) thereof according to the method are substantially the same as described above for the white ink composition. In some examples, the amount (by weight) of hollow cross-linked polymer particles in the white ink composition to achieve the above goal is about 0.1% to 5%. In some examples, the hollow cross-linked polymer particles and the amount (by weight) thereof in the white ink composition according to the method are substantially the same as described above for the white ink composition. In some examples, the white ink composition made by the method is substantially the same as the white ink composition described above.

Some examples in accordance with the principles described herein are directed to a print medium comprising at least one feature comprising a white ink composition as described above. In some examples in accordance with the principles described herein, the at least one feature of the print medium is obtained by dispensing a white ink composition to a surface of a print medium substrate that comprises an ink-receiving layer on one or both sides of the print medium substrate. The ink-receiving layer may be an integral part of the print medium substrate or the ink-receiving layer may be a separate layer associated with one or more surfaces of the print medium substrate. The phrase “associated with” refers to the attachment of the ink-receiving layer to the print medium substrate.

The print medium substrate comprises a material that serves as a base for a separate ink-receiving layer when the print medium substrate does not have the ability to act as an ink-receiving layer. The print medium substrate provides integrity for the resultant print medium. A print medium substrate that has an integral ink-receiving layer should have one or both of good affinity and good compatibility for the ink that is applied to the material. Examples of print medium substrates include, but are not limited to, natural cellulosic material, synthetic cellulosic material (such as, for example, cellulose diacetate, cellulose triacetate, cellulose propionate, cellulose butyrate, cellulose acetate butyrate and nitrocellulose), a material comprising one or more polymers such as, for example, polyolefins, polyesters, polyamides, ethylene copolymers, polycarbonates, polyurethanes, polyalkylene oxides, polyester amides, polyethylene terephthalate, polyethylene, polystyrene, polypropylene, polycarbonate, polyvinyl acetal, polyalkyloxazolines, polyphenyl oxazolines, polyethylene-imines, polyvinyl pyrrolidones, and combinations of two or more of the above, for example. In some examples the print medium substrate comprises a paper base including, for example, paper, cardboard, paperboard, foam board, paper laminated with plastics, paper coated with resin and textiles, or photoglossy media, for example.

The print medium substrate may be planar or such other shape that is suitable for the particular purpose for which it is employed. The print medium substrate may be one or more of smooth or rough, textured or non-textured, rigid, semi-rigid, or flexible, for example. The print medium substrate may have a surface that is porous or non-porous. For non-porous surfaces the print medium substrate will have a porous ink-receiving layer. Planar substrates may be in the form, for example, of a film, plate, board, or sheet by way of illustration and not limitation.

In some examples in accordance with the principles described herein, the print medium substrate has a thickness of about 0.025 mm to about 10 mm, or about 0.05 mm to about 10 mm, or about 0.1 mm to about 10 mm, or about 0.1 mm to about 5 mm, or about 0.1 mm to about 1 mm, or about 0.1 mm to about 0.6 mm, or about 0.5 mm to about 10 mm, or about 0.5 mm to about 5 mm, or about 0.5 mm to about 1 mm, or about 0.5 mm to about 0.6 mm, or about 1 mm to about 10 mm, or about 1 mm to about 5 mm, or about 1 mm to about 2 mm, for example. The basis weight of the print medium substrate is dependent on the nature of the application of the print medium where lighter weights are employed for magazines and tri-folds and heavier weights are employed for post cards, for example.

An ink-receiving layer as a separate layer is able to absorb liquid applied to it and is in that sense porous. The ink-receiving layer may be comprised of one or both of an inorganic material or an organic material. Examples of inorganic materials include, but are not limited to, metal oxides or semi-metal oxides such as, for example, silica, alumina, hydrous alumina (for example, boehmite and pseudo-boehmite), calcium carbonate, silicates (for example, aluminum silicate and magnesium silicate), titania, zirconia, calcium carbonate, and clays, and combinations thereof. Examples of organic materials include, but are not limited to, organic polymeric compositions comprising one or more polymers such as, for example, polyolefins, polyesters, polyamides, ethylene copolymers, polycarbonates, polyurethanes, polyalkylene oxides, polyester amides, polyalkyloxazolines, polyphenyl oxazolines, polyethylene-imines, polyvinyl pyrrolidones, and combinations of two or more of the above.

In some examples the porous ink receiving layer is associated with a print medium substrate by a deposition process including, but not limited to, roll-coating, conventional slot-die processing, blade coating, slot-die cascade coating, curtain coating, spray-coating, immersion-coating, and cast-coating, for example.

In some examples, the print medium substrate is a photobase, which is a substrate used in coated photographic papers. Photobase includes a paper base extruded on one or both sides with polymers, such as polyethylene and polypropylene. Photobase support can include a photobase material including a highly sized paper extruded with a layer of polyethylene on both sides. In this regard, the photobase support is an opaque water-resistant material exhibiting qualities of silver halide paper. The photobase support can include a polyethylene layer having a thickness of about 10 to 24 gsm. The photobase support can also be made of transparent or opaque photographic material.

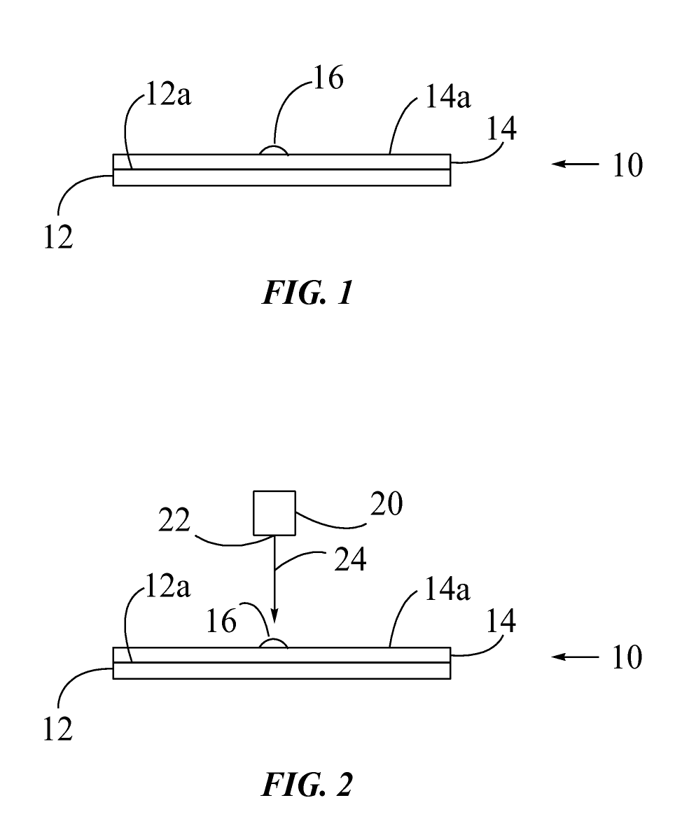

An example in accordance with the principles described herein is set forth in FIG. 1. FIG. 1 illustrates a schematic of a print medium 10 that comprises a print medium substrate 12 having an ink-receiving layer 14 on a surface 12a of the print medium substrate 12. Feature 16 comprising a white ink composition in accordance with the principles described herein is disposed on a surface 14a of the ink-receiving layer 14 of the print medium substrate 12.

Surfactants present in the white ink composition may include, for example, anionic surfactants such as, for example, sodium dodecylsulfate, sodium dodecyloxysulfonate and sodium alkylbenzenesulfonate; cationic surfactants such as, for example, cetylpyridinium chloride, trimethylcetylammonium chloride and tetrabutylammonium chloride; and nonionic surfactants such as, for example, polyoxyethylene nonylphenyl ether, polyoxyethylene naphthyl ether and polyoxyethylene octylphenyl ether. Other surfactants include, but are not limited to, amphoteric surfactants, silicon-free surfactants, ethoxylated surfactants, fluorosurfactants, alkyl polyethylene oxides, alkyl phenyl polyethylene oxides, polyethylene oxide block copolymers, and polysiloxanes, for example, and combinations thereof.

Examples of suitable biocides that may be present in the white ink composition include, but are not limited to, benzoate salts, sorbate salts, commercial products such as NUOSEPT® (Ashland Special Ingredients, Wayne N.J.), UCARCIDE® (Dow Chemical Company, Midland Mich.), VANCIDE® (R.T. Vanderbilt Company, Inc., Norwalk Conn.), PROXEL® (Avecia OligoMedicines, Inc., Milford Mass.), and KORDEK® MLX (Dow Chemical Company), for example.

Specific examples of anti-foaming agents that are commercially available include, but are not limited to, FOAMEX® 800, FOAMEX® 805, FOAMEX® 845, FOAMEX® 842, FOAMEX® 835, (all available from Evonik Tego Chemie Service GmbH, Essen, Germany) and TWIN® 4000 (Evonik Tego Chemie Service GmbH); BYK® 019, BYK® 028, BYK® 029 (available from BYK Chemie GmbH, Wesel, Germany); and SURFYNOL® 104, SURFYNOL® MD30 (all available from Air Products and Chemicals, Inc., Allentown Pa.), for example.

In some examples the white ink composition may be prepared by combining the white pigment particles, the hollow cross-linked polymer particles and other additives in a suitable aqueous ink vehicle, such as those described above. The combination is subjected to conditions under which the ink composition becomes substantially uniformly dispersed and then the combination is subjected to filtration to remove any large particles that may prohibit reliable jetting.

In some examples, conditions for rendering the white ink composition to a substantially uniform dispersion include, for example, agitation such as, e.g., one or more of mixing, stirring, shaking, homogenizing, sonication, ultrasonication, microfluidization, bead milling, and blending, for example, or a combination of the above. In some examples the temperature during the above procedure may be, for example, about 10° C. to about 40° C. In some examples the temperature is ambient temperature. The duration of the above treatment may be, for example, about 0.5 hours to about 5 hours. The phrase “substantially uniform” means that there is no visible phase separation.

Filtration of the ink composition may be carried out using, by way of illustration and not limitation, one or more of membrane filtration, surface filtration, depth filtration, screen filtration, and filtration aid, for example. The pore size of the filtration substrate should be large enough to allow targeted particles to pass through the substrate, but small enough to retain larger particles.

In some examples in accordance with the principles described herein, the white ink compositions find use as inkjet inks for inkjet printers Inkjet printers are now very common and affordable and allow one to obtain decent print quality. They are used in home printing, office printing and commercial printing. The growth of inkjet printing is the result of a number of factors including reductions in cost of inkjet printers and improvements in print resolution and overall print quality. A continued demand in inkjet printing has resulted in the need to produce images of high quality, high permanence and high durability while maintaining a reasonable cost Inkjet printing is also a popular method of non-contact printing on a broad selection of substrates to produce images comprising a variety of colors.

In some examples the white ink compositions may be dispensed to the surface of a broad range of print media employing inkjet technology and equipment. In some examples, the white ink compositions in accordance with the principles described herein may be dispensed from any drop-on-demand inkjet printing devices, either piezoelectric or thermal, and many such devices are commercially available. Such inkjet printing devices are available from Hewlett-Packard, Inc., Palo Alto, Calif., by way of illustration and not limitation. In inkjet printing devices for inkjet printing, liquid ink drops are applied in a controlled fashion to a print medium by ejecting ink droplets from a plurality of nozzles, or orifices, in a print head of an inkjet printing device or inkjet printer. In drop-on-demand systems, a droplet of ink is ejected from an orifice directly to a position on the surface of a print medium by pressure created by, for example, a piezoelectric device, an acoustic device, or a thermal process (e.g., thermal inkjet ‘TIJ’) controlled in accordance with digital data signals. An ink droplet is not generated and ejected through the orifices of the print head unless it is needed. The volume of the ejected ink drop is controlled mainly with the print head.

For inkjet printing the white ink composition in accordance with the principles described herein may be heated or chilled to an appropriate dispensation temperature prior to ejecting the ink composition to the surface of a substrate. The particular temperature and viscosity of the white ink composition is dependent on, for example, the particular method and equipment for conducting the inkjet printing. Considerations regarding temperature and viscosity of the white ink composition relate to the effect on droplet size and droplet ejecting rate, for example. In some examples, a jetting temperature is within the ranges of the dispensation temperature described above. In some examples the temperature is maintained relatively constant, which means that the temperature variation is controlled so that there is no more than a variation of ±1° C., or ±0.5° C., or ±0.2° C., or ±0.1° C., for example. Temperature control is achieved with appropriate temperature sensors, for example. In some examples, the temperature of a print medium during the printing process may be in the range of about 25° C. to about 90° C., for example.

The printed or jetted ink may be dried after jetting the white ink composition in a predetermined pattern onto a surface of a print medium. The drying stage may be conducted, by way of illustration and not limitation, by hot air, electrical heater or light irradiation (e.g., IR lamps), or a combination of such drying methods. In order to achieve best performance it is advisable to dry the ink at a maximum temperature allowable by the print medium that enables good image quality without print medium deformation. In some examples, a temperature during drying is about 40° C. to about 150° C., for example. Drying the printed ink includes evaporating the liquid ink vehicle from the hollow interiors of the hollow particles. When dried, the void space in the hollow interiors of the hollow particles is replaced with ambient fluid, e.g., air.

In some examples, a printed feature of the print medium may have a thickness that is between about 40 nm and about 600 nm or between about 50 nm and about 400 nm. In some examples, the thickness of the printed feature depends upon the user and the targeted application for the printed medium.

FIG. 2 is schematic illustrating the formation of the print medium 10 having at least one feature 16 of FIG. 1 according to an example in accordance with the principles described herein. A printer print head nozzle 20 has an orifice 22 that dispenses droplets of the white ink composition in accordance with the principles described herein along trajectory 24 to surface 14a of the ink-receiving layer 14 to form the feature 16.

### DEFINITIONS

The following provides definitions for terms and phrases used above, which were not previously defined.

The phrase “at least” as used herein means that the number of specified items may be equal to or greater than the number recited. The phrase “about” as used herein means within the measurement tolerance of the equipment used to produce the value, or in some examples, means that the number recited may differ by plus or minus (±) 10%; or ±5%, or ±1%, for example. The term “between” when used in conjunction with two numbers such as, for example, “between about 2 and about 50” includes both of the numbers recited.

Numerical values, such as ratios, amounts, temperatures and time periods, for example, may be presented herein in a range format. It is to be understood that such range format is used merely for convenience and brevity and should be interpreted to include not only the numerical values explicitly recited as the limits of the range, but also to include all the individual numerical values or sub-ranges encompassed within that range as if each numerical value and sub-range is explicitly recited.

As used herein, the singular forms “a”, “an” and “the” include plural referents unless the content clearly dictates otherwise. In some instances, “a” or “an” as used herein means “at least one” or “one or more.” Designations such as “first” and “second” are used solely for the purpose of differentiating between two items and are not meant to imply any sequence or order or importance to one item over another or any order of operation, for example.

### EXAMPLES

The following examples are by way of illustration and not limitation on the scope of the principles described herein and the appended claims. Numerous modifications and alternative compositions, methods, and systems may be devised without departing from the spirit and scope of the principles described herein. Unless otherwise indicated, materials in the experiments below may be purchased from Aldrich Chemical Company, St. Louis Mo. Parts and percentages are by weight unless indicated otherwise.

### Example 1

### Ink Compositions

A white ink composition A is prepared based on dispersions containing TiO₂ nanoparticles. The dispersion is produced by milling nanoparticle TiO₂ powder—Ti-Pure R-900 (E. I. du Pont de Nemours and Company (DuPont), Wilmington, Del.) in a Netzsch Mini-Cer (Netzsch Fine Particle Technology, Exton, Pa.) with a dispersant, 3-(trihydroxysilyl)propyl methylphosphonate, monosodium salt (Gelest Inc., Morrisville Pa.) at a dispersant/metal oxide particles ratio equal to 0.13. The resulting dispersion contains about 47.4 weight percent (wt %) of TiO₂ particles. The average particle size of the TiO₂ particles is about 233 nm as measured by a Nanotrack® particle size analyzer (Microtrac Corp., Montgomeryville Pa.). The dispersion is then used to produce the ink composition A as summarized in Table 1.

TABLE 1

| Ink Formulation | A |
|---|---|
| TiO₂ Dispersion | 10.55 |
| ROPAQUE ® Ultra E | 2.00 |
| Polyurethane | 1.00 |
| LEG-1 | 5.00 |
| 2-Pyrrolidinone | 9.00 |
| PROXEL ® GXL | 0.10 |
| SURFYNOL ® 465 | 0.20 |
| Water | Up to 100% |

LEG-1 is a branched ethylene glycol (available from Liponics Technologies, West Sacramento, Calif.). PROXEL®GXL is a biocide (available from Arch Chemicals, Norwalk, Conn.). SURFYNOL®465 is a surfactant from Air Products and Chemicals, Inc., Allentown, Pa. Polyurethane is a polyurethane additive (water-soluble polymers) having an acid number of about 53 mg/g KOH. ROPAQUE® Ultra E is hollow spheres with cross-linked polymer shells available from Dow Chemical Company, Midland, Mich.).

### Example 2

### Printable Media

A printable recording medium is produced with a single pass (wet-on-wet) coating method using a curtain coater. An ink-absorbing layer and eventually, a glossy layer are applied onto a photobase (“HP Advanced Photo Paper”, Hewlett Packard, Palo Alto, Calif.) as a supporting substrate (166 or 171 g/m² raw base paper). The ink-absorbing layer is applied first to a front side of the photobase with a roller coater. When present, the glossy layer is coated on the top of the ink-absorbing layer. The coat weight of the ink absorbing layer is from 10 to 40 grams per square meter (gsm) and the coat weight of the glossy layer is from 0.1 to 2 gsm. The formulations of the different coating layers are expressed in the Table 2 below. Each number represents the part per weight of each component present in each layer. Media (α) is media with a glossy layer and Media (β) is media without a glossy layer.

TABLE 2

| Layer | Ingredients | Media (α) | Media (β) |
|---|---|---|---|
| Glossy protective | DISPERAL ®HP-14 | 75 | — |
| layer | CARTACOAT ®K303C | 25 | — |
| | PVA 2 | 11 | — |
| Coat-weight | | 0.5 gsm | — |
| Ink-absorbing | Treated Silica | 100 | 100 |
| layer | PVA 1 | 21 | 21 |
| | Boric Acid | 2.5 | 2.5 |
| | SILWET ®L-7600 | 0.5 | 0.5 |
| | Glycerol | 1.5 | 1.5 |
| | ZONYL ®FSN | 0.1 | 0.1 |
| Coat-weight | | 28 gsm | 28 gsm |

Treated silica is CAB-O-SIL®MS-55 (available from Cabot Corporation, Boston, Mass.) treated with aluminum chlorohydrate (ACH) and SILQUEST®A-1110 (Momentive Performance Materials, Wilton Conn.). PVA is polyvinyl alcohol. PVA 1 is POVAL®235 available from Kuraray America, Inc., Houston, Tex. PVA 2 is MOWIOL® 40-88 available from Kuraray. ZONYL®FSN is a fluorosurfactant available from DuPont. CARTACOAT®K303C is cationic colloidal silica available from Clariant Corporation, Charlotte, N.C. DISPERAL®HP-14 is boehmite available from Sasol Technologies Inc., Johannesburg, South Africa. SILWET®L-7600 is a surfactant from GE Silicones Inc., Wilton Conn.). A black background was produced on the printable media by printing black dye based ink, HP 02 Black Ink (Hewlett Packard), by using a HP PHOTOSMART® D7160 (Hewlett Packard) in such a way that L* value of final print media is about 10.

### Example 3

### Ink Performance

Printed articles with white opaque appearance are produced by applying the ink formulations (prepared in a manner similar to that described in Example 1), the compositions of which are set forth in detail in Table 3. Each formulation contains a dispersion of white pigment particles Ink formulations are dispensed onto the surface of a printable media by means of a thermal inkjet printhead. Prints with white opaque appearance are produced by printing of ink formulations on “HP Advanced Photo Paper” (such as described in Example 2) using a HP Cartridge 940 in a HP Office Jet Pro 8000 printer (Hewlett Packard). The resulting printed articles have a white opaque visual appearance.

One hour after printing, the printed articles are subjected to color measurements (L* value) based on a CIELAB® color space system with SPECTROEYE™ (Gretag-Macbeth AG, New Windsor, N.Y.). L* is as defined in CIELAB®, which is color space specified by the International Commission on Illumination. Impact of the white pigment, the hollow spheres and the soluble polyurethane additions on the L* values of the white opaque article (printed at ink flux of about 500 picoliters (pL)/300^{th} pixel) is summarized in Table 3.

The visual white opaque appearance data of the printed articles produced at different levels of the white pigment, the hollow spheres and the soluble polyurethane (summarized in Table 3) illustrate the impact of the hollow spheres and/or soluble polyurethane addition on white opaque appearance of the resulting prints. All printed articles have improved white opaque appearance (L* value of above 72 to 96) compared to use of the white pigment or the hollow spheres only. For reference, maximum L* value obtained at various white pigment loads only is 72, or obtained at various hollow sphere levels only is 71.

TABLE 3
L* values

| | Soluble | ROPAQUE | ROPAQUE | ROPAQUE | ROPAQUE |
|---|---|---|---|---|---|
| TiO₂ | Polyurethane | 0% | 1% | 2% | 4% |
| 0% | 0% | 10 | — | — | 71 |
| 2.5% | 0% | 61 | 77 | 80 | 85 |
| 5% | 0% | 72 | 81 | 86 | 92 |
| | 1% | 72 | 88 | 91 | — |
| | 2% | 80 | 84 | 91 | — |
| 20% | 0% | 72 | 74 | 77 | 82 |
| | 1% | — | 94 | 96 | — |
| | 2% | — | 93 | 96 | — |

It should be understood that the above-described examples are merely illustrative of some of the many specific examples that represent the principles described herein. Clearly, those skilled in the art can readily devise numerous other arrangements without departing from the scope as defined by the following claims.

1. A white ink composition comprising:
an aqueous ink vehicle;
white pigment particles;
and
hollow particles comprising a cross-linked polymer shell,
wherein the white ink composition is in an inkjet ink cartridge and has a viscosity of 50 centipoise or less, and wherein an amount of hollow particles in the white ink composition is 0.1% to 4.0% by weight.

2. The white ink composition according to claim 1, wherein the white pigment particles are selected from the group consisting of titanium dioxide, zinc oxide, calcium carbonate, barium sulfate, aluminum trihydrate, antimony trioxide, calcium sulfate, kaolin, lead sulfate, silicon dioxide, barium carbonate, hydrated forms thereof, and mixtures thereof.

3. The white ink composition according to claim 1, wherein the hollow particles have an average diameter of about 100 to about 600 nanometers.

4. The white ink composition according to claim 1, wherein the cross-linked polymer shell of the hollow particles has a thickness of about 15 nanometers to about 200 nanometers.

5. The white ink composition according to claim 1, wherein the white pigment particles comprise a silane coupling agent.

6. The white ink composition according to claim 1, wherein the polymer of the cross-linked polymer shell is selected from the group consisting of methyl methacrylate, methacrylic acid, ethylene glycol dimethacrylate, styrene, acrylonitrile, divinyl benzene, and mixtures thereof.

7. The white ink composition according to claim 1, further comprising a soluble polyurethane.

8. A print medium comprising at least one feature comprising the white ink composition according to claim 1, wherein the at least one feature has an L* value greater than 70.

9. A printing device comprising:
an inkjet ink cartridge and
a white ink composition contained within the inkjet ink cartridge, the white ink composition comprising:
an aqueous ink vehicle;
about 1% to about 25% by weight of titanium dioxide particles;
and
about 0.1% to 4.0% by weight of hollow particles comprising a cross-linked polymer shell,
wherein the white ink composition has a viscosity of 50 centipoise or less.

10. The printing device according to claim 9, wherein the hollow particles of the white ink composition have an average diameter of about 200 to about 600 nanometers, and wherein the cross-linked polymer shell of the hollow particles has a thickness of about 40 nanometers to about 60 nanometers.

11. The printing device according to claim 9, wherein the titanium dioxide particles of the white ink composition comprise about 0.05% to about 25% of a silane coupling agent.

12. The printing device composition according to claim 9, wherein the titanium dioxide particles have an average diameter of about 150 nanometers to about 400 nanometers.

13. The printing device according to claim 9, wherein the white ink composition further comprises a soluble polyurethane wherein the amount of the soluble polyurethane is about 0.1% to about 5% by weight.

14. A method of reducing an amount of white pigment particles in a white inkjet ink composition, the method comprising: incorporating, into the white ink composition, hollow cross-linked polymer particles in an amount sufficient to reduce the amount of white pigment particles in the white ink composition to about 1% to about 25% by weight, wherein the hollow cross-linked polymer particles comprise a cross-linked polymer shell, and wherein the amount of hollow cross-linked polymer particles in the white ink composition is 0.1% to 4.0% by weight.

15. The method according to claim 14, wherein the hollow cross-linked polymer particles have an average diameter of about 100 nanometers to about 600 nanometers, and wherein the cross-linked polymer shell of the hollow particles has a thickness of about 15 nanometers to about 200 nanometers.
